(19) United States
(12) Patent Application Publication
(10) Pub. No.: US 2008/0143159 A1
(43) Pub. Date: Jun. 19, 2008

(54) Walk-in sliding seat of a tip-up type

(75) Inventor: Dae Sub Song, Gyeonggi-do (KR)

Correspondence Address: EDWARDS ANGELL PALMER & DODGE LLP, P.O. BOX 55874, BOSTON, MA, 02205, US

(73) Assignee: Kia Motors Corporation, Seoul (KR)

(21) Appl. No.: 11/715,615

(22) Filed: Mar. 7, 2007

(30) Foreign Application Priority Data
Dec. 13, 2006 (KR) 10-2006-0126873

(51) Int. Cl. B60N 2/12

(52) U.S. Cl. 297/317

(57) ABSTRACT

The present invention provides a tip-up type walk-in sliding seat structure, comprising: a seat cushion; a cushion roller provided at a front part of the seat cushion; a striker coupled to a rear part of the seat cushion; a seat back having a latch which is coupled to the striker so as to be released during walk-in tip-up sliding operation thereby separating the seat cushion from the seat back; a main body connected to a side part of the seat back; a seat back roller provided at a lower part of the main body; a seat rail with which the cushion roller and the seat back roller are slidably engaged; and a link connector which is connected to the seat cushion and a lower part of the main body so as to raise a rear part of the seat cushion in response to forward sliding of the seat back.

### CROSS-REFERENCE TO RELATED APPLICATION

This application claims priority to and the benefit of Korean Patent Application No. 10-2006-0126873, filed Dec. 13, 2006, the entire contents of which are incorporated herein by reference.

### BACKGROUND OF THE INVENTION

(a) Field of the Invention

The present invention relates to a tip-up type walk-in sliding seat structure, and more particularly to a tip-up type walk-in sliding seat structure in which a seat cushion and a seat back are connected to one another by a link connector so that the seat cushion is tipped-up in response to operation of the seat back which slides, thereby increasing space for a passenger to get in or out of a vehicle.

(b) Background Art

Generally, a second-row seat can perform its function by double folding and walk-in sliding while a passenger of a third-row seat gets in or out of a vehicle.

A second-row seat of double folding type has sufficient lower space. The whole seat, however, should be raised after double folding of the seat back.

A second-row seat of walk-in sliding type can be conveniently manipulated. The layout of a vehicle (i.e., limit of amount of forward sliding by a front seat) with such second-row seat, however, makes it difficult to obtain a sufficient lower space so that a space for a passenger to get in and out of a vehicle is not sufficient.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a tip-up type walk-in sliding seat structure to overcome the above-described problems in prior art. More specifically, the present invention has been made in an effort to provide a tip-up type walk-in sliding seat structure in which a seat cushion is separated from a seat back during walk-in tip-up sliding and a rear part of the seat cushion is raised, in response to forward movement of the seat back, by a link connector connected to the seat cushion so as to move forward thereby enlarging a rear space.

The present invention has also been made in an effort to provide a tip-up type walk-in sliding seat structure in which a seat back is provided with a latch, a seat cushion is provided with a striker, the latch is releasably coupled to the striker, and if the latch is released, the seat cushion is raised to a specific angel by restoration force of a restoration spring of the seat cushion, and the seat cushion is raised and rotated by the link connector in response to movement of the seat back.

In one aspect, the present invention provides a tip-up type walk-in sliding seat structure, comprising: a seat cushion; a cushion roller provided at a front part of the seat cushion; a striker coupled to a rear part of the seat cushion; a seat back having a latch which is coupled to the striker so as to be released during walk-in tip-up sliding operation thereby separating the seat cushion from the seat back; a main body connected to a side part of the seat back; a seat back roller provided at a lower part of the main body; a seat rail with which the cushion roller and the seat back roller are slidably engaged; and a link connector which is connected to the seat cushion and a lower part of the main body so as to raise a rear part of the seat cushion in response to forward sliding of the seat back.

In a preferred embodiment, the seat cushion further comprises: a hinge shaft which is connected to the cushion roller at a front part thereof; and a restoration spring which is winded around the hinge shaft such that a rear part of the seat cushion can be raised to a specific angle by restoration force of the restoration spring.

In another preferred embodiment, the seat back further comprises a tip-up lever configured for being able to release the latch.

In still another preferred embodiment, the seat rail further comprises a stopper which is provided at an upper part thereof so as to prevent the cushion roller from moving rearward any more when the seat cushion is restored.

In another aspect, motor vehicles are provided that comprise a described seat structure.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like. The present seat structures will be particularly useful with a wide variety of motor vehicles.

Other aspects of the invention are discussed infra.

### BRIEF DESCRIPTION OF THE DRAWINGS

The present invention will be better understood from reading the description which follows, given by way of non-limiting example, with reference to the attached drawings.

FIG. 1 is a drawing showing a tip-up type walk-in sliding seat structure according to an exemplary embodiment of the present invention.

FIG. 2A is a drawing showing a portion A of FIG. 1.

FIG. 2B is a drawing showing a portion B of FIG. 1.

FIG. 3A is a drawing showing a mode of operation of tip-up type walk-in sliding seat structure according to an exemplary embodiment of the present invention.

FIG. 3B is a drawing showing a mode of operation of tip-up type walk-in sliding seat structure according to an exemplary embodiment of the present invention.

Reference numerals set forth in the Drawings includes reference to the following elements as further discussed below:

| | |
|---|---|
| 1: a tip-up type walk-in sliding seat structure | |
| 10: seat cushion | 11: striker |
| 13: hinge shaft | 15: cushion roller |
| 17: connecting bracket | 20: seat back |
| 21: main body | 23: latch |
| 25: seat back roller | 27: tip-up lever |
| 30: restoration spring | 40: link connector |
| 50: seat rail | 60: stopper |

### DETAILED DESCRIPTION

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

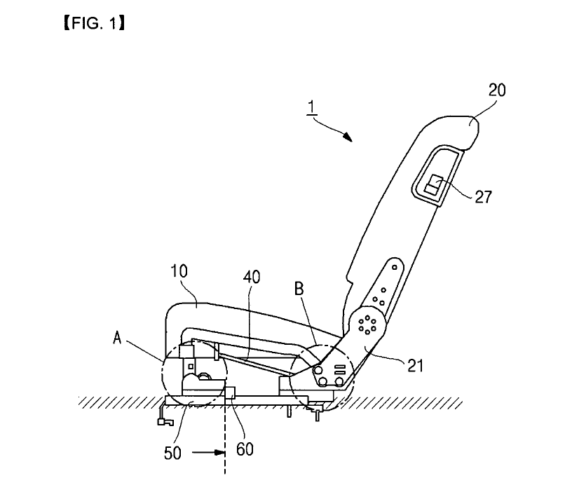

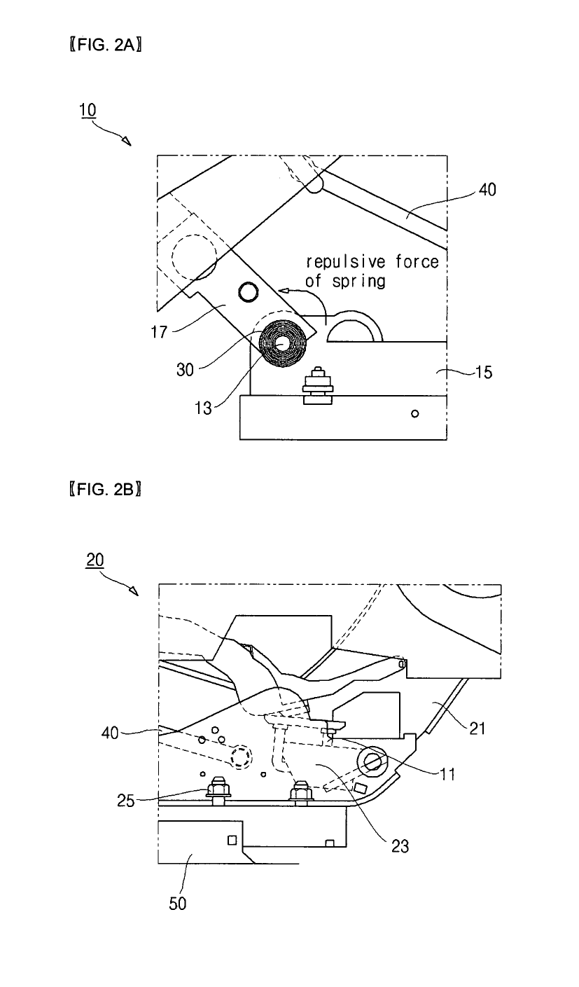

As discussed above, in one aspect, the present invention provides a tip-up type walk-in sliding seat structure. FIG. 1 is a drawing showing a tip-up type walk-in sliding seat structure according to an exemplary embodiment of the present invention, FIG. 2A is a drawing showing a portion A of FIG. 1, and FIG. 2B is a drawing showing a portion B of FIG. 1.

As shown in FIG. 1 to FIG. 2B, a tip-up type walk-in sliding seat structure 1 includes a seat cushion 10, a seat back 20, a link connector 40 interconnecting these two members, and a seat rail 50.

The seat cushion 10 includes a cushion roller 15 connected to a hinge shaft 13 at a front portion thereof, a striker 11 at a rear portion thereof, and a restoration spring 30 which is winded around the hinge shaft 13.

The seat back 20 includes a main body 21 to which a latch 23 is coupled, a seat back roller 25, and a tip-up lever 27.

The seat rail 50 is provided at a lower side of the tip-up type walk-in sliding seat structure to be slidable.

A connecting bracket 17 is coupled to the hinge shaft 13 at a front portion of the seat cushion 10, the hinge shaft 13 is connected to the cushion roller 15, and the striker 11 is provided to a rear portion of the seat cushion 10.

As shown in FIG. 2A, the cushion roller 15 is connected to a lower portion of the seat cushion 10 and is provided with a wheel so as to be slidable. The wheel is inserted into the seat rail 50 so that the cushion roller 15 is slidable.

The restoration spring 30 is winded around the hinge shaft 13 for enabling the seat cushion 10 to rotate.

The seat cushion 10 is raised to a specific angle at an initial stage by restoration force of the restoration spring 30. An end of the restoration spring 30 is connected to the cushion roller 15.

As shown in FIG. 2B, the striker 11 is provided at a lower side of a rear portion of the seat cushion 10 to be coupled to the latch 23, and can preferably be separated from the latch 23 during tip-up walk-in sliding operation.

The seat back 20 includes the main body 21 to which the latch 23 is coupled, the seat back roller 25, and the tip-up lever 27.

A reclining device (not shown) for rotation of the seat back 20 is provided at a center of the main body 21. The latch 23 is provided such that an upper part of the main body 21 can be coupled to the seat back 20 and a lower part of the main body 21 can be coupled to the seat cushion 10. The seat back roller 25 is provided at a lower part thereof.

The tip-up lever 27 is provided to an outer upper end of the seat back 20 and is connected to the latch 23.

The latch 23 is coupled to the striker 11. Preferably, the latch 23 can be released from the striker 11 if the tip-up lever 27 is operated.

The seat back roller 25 is connected to a lower part of the main body 21. The seat back roller 25 is provided with a wheel so as to be slidable and is inserted into the seat rail 50 so as to be movable.

That is, the striker 11 which is provided at a rear part of the seat cushion 10 is coupled to the latch 23 provided to the main body 21 of the seat back 20.

If the tip-up lever 27 which is provided to an upper part of the seat back 20 is operated (up), it is preferable that the latch 23 is released from the striker 11 so that a rear part of the seat cushion 10 rises.

The link connector 40 is provided such that the seat cushion 10 is rotated and raised in response to movement of the seat back 20 which slides when the latch 23 is released.

As shown in FIG. 1, one end of the link connector 40 is connected to a front part of the seat cushion 10, and the other end thereof is connected to a lower end part of the main body 21. If the seat back 20 is moved in a forward direction, the seat cushion 10 slides to move forward while it is raised by the link connector 40.

The cushion roller 15 provided to a lower part of the seat cushion 10 and the seat back roller 25 provided to the main body 21 of the seat back 20 are inserted into the seat rail 50 so as to be slidable in forward and rearward direction. A stopper 60 is provided to the seat rail 50 for stopping the cushion roller 15 at the restoration position.

The stopper 60 is mounted on the seat rail 50 at a position where the seat cushion 10 is lowered to be locked when the cushion roller 15 moves rearward, thereby preventing the cushion roller 15 from not moving rearward any more.

Accordingly, in the tip-up type walk-in sliding seat 1 in which the striker 11 of the seat cushion 10 and the latch 23 of the main body 21 are coupled to one another, if the latch 23 is released, the seat cushion 10 is raised to a specific angle by the restoration force of the restoration spring 30 which is winded around the hinge shaft 13 connecting the seat cushion 10.

If the seat back 20 is pushed in a forward direction, a rear part of the seat cushion 10 is raised and rotated by the link connector 40.

Operation of a tip-up type walk-in sliding seat structure according to an exemplary embodiment of the present invention will be briefly explained hereinafter.

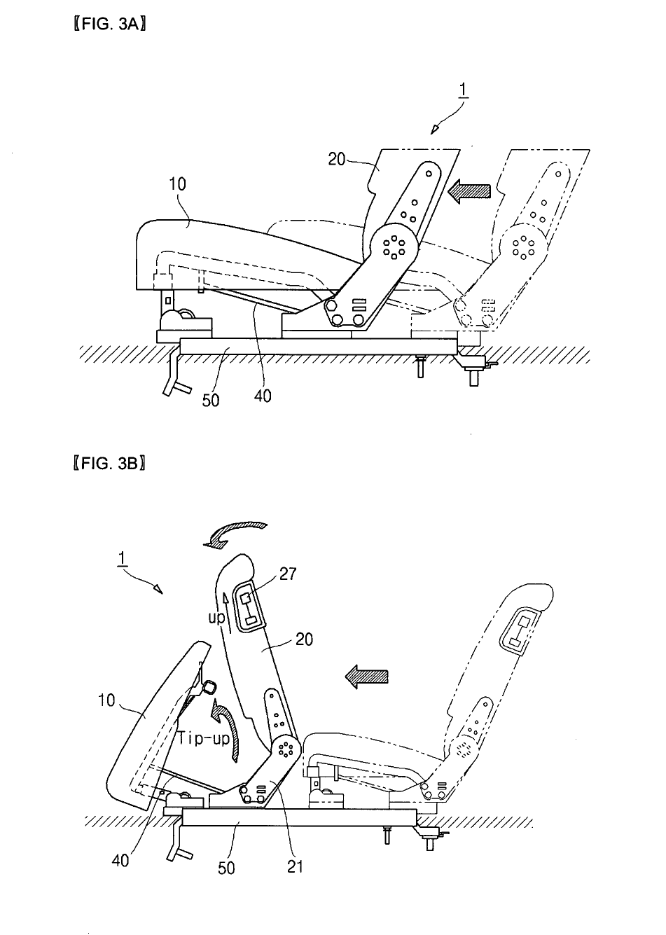

FIGS. 3A and 3B shows modes of operation of a tip-up type walk-in sliding seat structure according to an exemplary embodiment of the present invention.

As shown in FIG. 3A, the seat back 20 and the seat cushion 10 are maintained to be locked by the latch 23 so as to be slidable. At a maximum forward position, a cargo room (not shown) can be enlarged.

As shown in FIG. 3B, in a walk-in tip-up sliding, the tip-up lever 27 is operated, and the latch 23 of the seat cushion 10 is released so as to undergo tip-up movement.

Then, the seat back 20 is reclined in a forward direction, and the main body 21 slides to move forward.

Accordingly, the seat cushion 10 is maximally tipped-up so to move forward.

More specifically, the rear part of the seat cushion 10 is separated from the main body 21 of the seat back 20 so that a front part thereof starts to rotate relative to the hinge shaft 13. At this time, the rear part of the seat cushion 10 is raised to a specific angle by the restoration force of the restoration spring 30 which is winded around the hinge shaft 13.

As the main body 21 slides forward, the rear part of the seat cushion 10 is raised by the link connector 40 which is connected to the seat back 20 so that the seat cushion 10 moves forward.

Accordingly, the tip-up type walk-in sliding seat 1 is maximally tipped-up and slides so as to additionally obtain a rear space.

As shown in FIG. 1, operation of the restoration of the tip-up type walk-in sliding seat structure 1 is as follows. If the seat back 20 is pulled in a rearward direction, the seat cushion 10 and the main body 21 move rearward.

At this time, the cushion roller 15 of the seat cushion 10 moves to a position of the stopper 60 within the seat rail 50, and the seat cushion 10 does not move rearward any more by the stopper 60.

Accordingly, only the main body 21 moves in a rearward direction, and the lower part of the seat cushion 10 is lowered to be locked by the link connector 40.

In a tip-up type walk-in sliding seat structure 1 according to an exemplary embodiment of the present invention, the seat cushion 10 and the seat back 20 are operated to be linked with the link connector 40 to slide and to be tipped-up, so that a maximum rear space can be obtained so as to enhance convenience of a passenger.

As described above, in a walk-in sliding seat of a tip-up type according to an exemplary embodiment of the present invention, as the latch of the seat cushion is released, the seat cushion is tipped-up and the seat moves forward, so that a space for a passenger to get in and get out can be maximized, thereby enhancing the convenience of a passenger.

A walk-in sliding seat of a tip-up type is maintained to be locked by the latch of the seat cushion in a normal state, and a cargo room can be enlarged when the seat moves in a forward direction.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A tip-up type walk-in sliding seat structure, comprising:
a seat cushion;
a cushion roller provided at a front part of the seat cushion;
a striker coupled to a rear part of the seat cushion;
a seat back having a latch which is coupled to the striker so as to be released during walk-in tip-up sliding operation thereby separating the seat cushion from the seat back;
a main body connected to a side part of the seat back;
a seat back roller provided at a lower part of the main body;
a seat rail with which the cushion roller and the seat back roller are slidably engaged; and
a link connector which is connected to the seat cushion and a lower part of the main body so as to raise a rear part of the seat cushion in response to forward sliding of the seat back.

2. The structure of claim 1, wherein the seat cushion further comprises:
a hinge shaft which is connected to the cushion roller at a front part thereof; and
a restoration spring which is winded around the hinge shaft such that a rear part of the seat cushion can be raised to a specific angle by restoration force of the restoration spring.

3. The structure of claim 1, wherein the seat back further comprises a tip-up lever configured for being able to release the latch.

4. The structure of claim 1, wherein the seat rail further comprises a stopper which is provided at an upper part thereof so as to prevent the cushion roller from moving rearward any more when the seat cushion is restored.
